(19) United States
(12) Patent Application Publication
(10) Pub. No.: US 2003/0168860 A1
(43) Pub. Date: Sep. 11, 2003

(54) Air-driven electric power generator

(76) Inventor: Robert William Jackson, Hinton, OK (US)

Correspondence Address: Robert William Jackson, RR2 Box 142, Hunton, OK, 73047, US

(21) Appl. No.: 10/136,063

(22) Filed: May 1, 2002

Related U.S. Application Data
(60) Provisional application No. 60/368,394, filed on Mar. 29, 2002.
(60) Provisional application No. 60/363,271, filed on Mar. 11, 2002.

(51) Int. Cl. H02P 9/04

(52) U.S. Cl. 290/1 R

(57) ABSTRACT

My concept of using pressurized air to generate electric power is more efficient and is environmentally friendly than other methods in use today. Thrust from air flow would produce torque by rotating the turbine which is connected to an electric generator. I believe this method to be more efficient than steam, internal combustion, or coal burning methods.

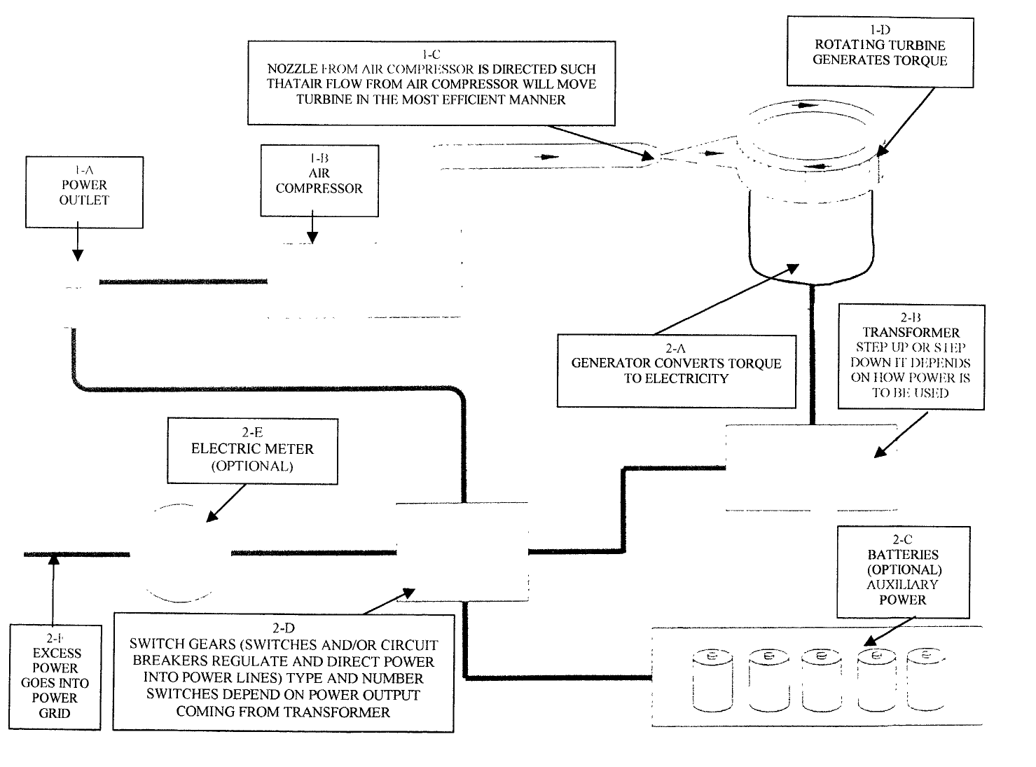

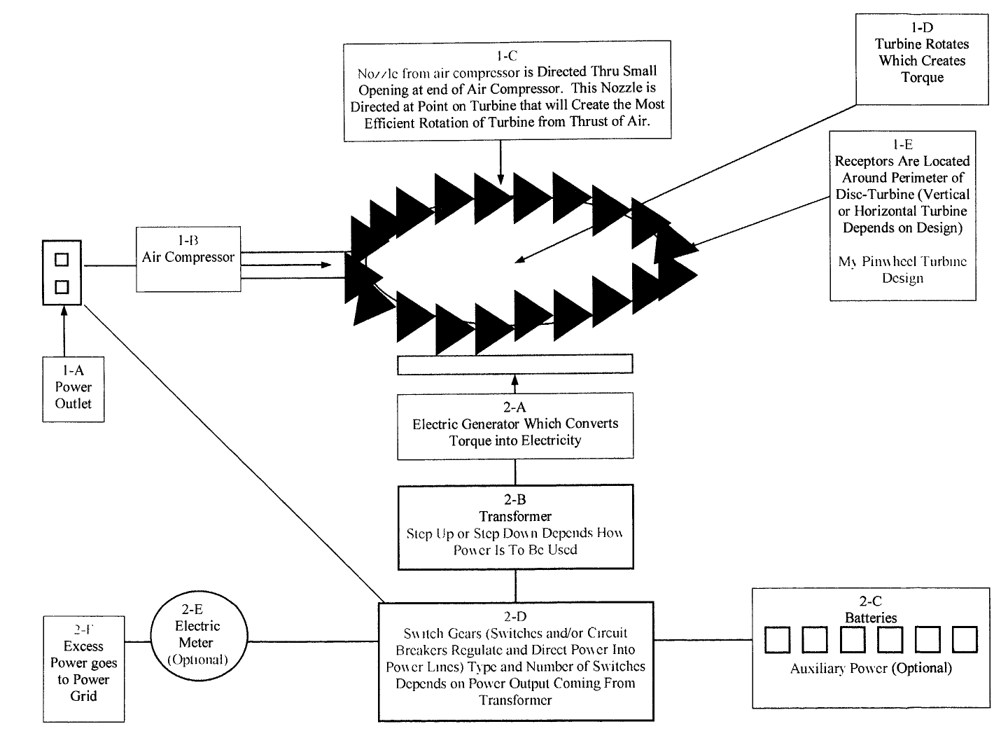

### BACKGROUND OF INVENTION

This theory was developed by Robert William Jackson. I claim to be the original inventor of this concept. This is a renewable energy device using basic air-flow principals. My idea is to use an air compressor (See 1-B, Sheet 1 and 2) with a high pressure nozzle (See 1-C, Sheet 1 and 2). The nozzle is then directed into a turbine (See 1-D, Sheet 1 and 2). The theory is to rotate the turbine which in turn is connected to an electric generator (See 2-A, Sheet 1 and 2). The theory is to rotate turbine with air-flow from nozzle which is connected to air-compressor. The pressure from air-flow which comes from end of nozzle should be direct at point of the turbine which creates the most efficient rotation of turbine (See 1-C, Sheet 1 and 2). This rotation of turbine creates torque (See 1-D, Sheet 1 and 2) in which generator converts into electricity (See 2-A, Sheet 1 and 2).

### BRIEF SUMMARY OF THE INVENTION

I claim you can create more electricity than what it takes to run the air-compressor. The device creates more power than what it takes to power the device.

### DETAILED DESCRIPTION OF INVENTION

The power used to run the air-compressor (See 1-A, Sheet 1 and 2) depends on the type of air-compressor that is used.

The nozzle from the air-compressor should have a small opening at the end (which creates more air pressure). The diameter of this opening should be the width which creates the most pounds per square inch pressure this particular air compressor can produce. The end of the nozzle is directed at the point on a turbine that will create the most efficient rotation of the turbine from the thrust of the air-flow (See 1-C, Sheet 1 and 2).

I claim the higher the pounds per square inch (PSI) rating of the air-compressor directly increases the power potential of the device. The compressor, generator and the design of the turbine all need to be in the right ratio. This means the generator and turbine need to be capable of generating more power than what it takes to run air-compressor. At the same time the air compressor needs to be capable of producing enough force to generate this amount of electricity. The nozzle and turbine need to be in proper alignment for the most efficient operation of this device (See 1-C, Sheet 1 and 2). This deals with the maximum rotation of turbine (See 1-D, Sheet 1 and 2) due to the PSI pressure coming from end of the nozzle which is connected to the air compressor. You can adjust power output by the pressure (PSI) coming thru the nozzle.

The electricity that the generator creates is directed into a transformer which decreases or increases the voltage (See 2-B, Sheet 1 and 2). Either way electricity that comes from transformer is directed into some kind of switch gear device (See 2-D, Sheet 1 and 2). This device regulates and directs the electric power. Electric meter or some sort could be used to measure the amount of electricity that comes from switch gear device (See 2-E, Sheet 1 and 2). This excess power goes into the power grid through power line (See 2-F, Sheet 1 and 2).

This unit does require initial start-up. There are a lot of ways of doing this from batteries (See 2-C, Sheet 1 and 2) gasoline generators or from any standard power source (See 1-A, Sheet 1 and 2).

The turbine design is very important. Here are few existing designs of turbines that would work with this concept. These turbines were designed for hydroelectric systems but could be adapted for this concept. I claim the Pelton, Harris, Banki, Nautilus and Neptune turbines would work with this concept. I like my own Pinwheel turbine design (See 1-E, Sheet 2). This design is patterned after the Pinwheel firework. My design is a solid disk. This disc should have at least 12 receptor cones positioned around the perimeter of the disc (dimensions are patterned after the Pinwheel firework). These receptors should be spaced evenly. I also believe that the receptors should point slightly outward from the disc for maximum retention of thrust from air-flow from the nozzle of the air-compressor. The size of the disc turbine shouldn't be much larger in diameter than the width of the generator on which it is connected (just not too big or too small for maximum efficiency of rotation of the turbine in which torque is created.

The blades or receptors of the turbine need to be spaced in such a way that they catch the fill thrust of the air-flow coming from the end of the nozzle.

My Pinwheel design has the receptor cones spaced close together around perimeter of the disc turbine. The round openings of the cone receptors receive the fill force of the air-flow coming from the end of nozzle.

With certain turbines you can line-up a second turbine to receive excess air-flow that receptors or blades on first turbine didn't capture. Second turbine will rotate a lot less but still be able to contribute to power output.

The turbine needs to be directly connected to the armature of the generator or the turbine needs to be connected to a spindle or rotor which is in turn is connected to the armature. It is important that armature rotates at same rate as turbine (Standard Generator Design).

The nozzle needs to be in a fixed position. This position needs to be at the precise point where thrust from air-flow creates the most efficient rotation of turbine. The air-compressor also needs to be in a secure position. The generator also needs to be in a secured position.

This device needs to be in a protected area with adequate ventilation (air supply). This area needs to be water and wind proof. Extreme heat or cold should be avoided for optimum performance of device.

I recommend an alternating current (AC) generator for best results even though a (DC) generator could be used.

1. I claim this concept to be a highly efficient way of producing electric power.

2. I claim this concept to be non-polluting and environmentally friendly.

3. I claim you can use alternating current (AC) generator or direct current generator (DC).

4. I claim you can connect multiple units together for larger power output.

5. I claim you can store excess power in batteries.

6. I claim my concept could be used with existing generators with a variety of turbines.

7. I claim my concept is more efficient than steam, internal combustion, or coal burning methods.

8. I claim as long as generator and turbine have the capacity to convert the torque that air-flow pressure creates, that the only restriction to power output is the pounds per square inch (PSI) rating of the air compressor.

9. I claim a reactor could be designed for large power output.

10. I claim utility companies can use this concept to generate electricity.

11. I claim homeowners can use this concept to generate electricity.

12. I claim emergency generators could be developed with this concept.

13. I claim industry could use this concept to generate electricity.

14. I claim automobiles could be powered with this concept.

15. I claim this concept could be use anywhere electricity is used.

16. I claim this a perpetual power concept with enormous potential.
